(19) United States
(12) Patent Application Publication
(10) Pub. No.: US 2008/0266209 A1
(43) Pub. Date: Oct. 30, 2008

(54) DISPLAY DEVICE

(75) Inventors: KUN-SHENG KUO, Chu-Nan (TW); CHUAN-FU YANG, Chu-Nan (TW); YUAN-FA CHU, Chu-Nan (TW)

Correspondence Address: PCE INDUSTRY, INC.;ATT. CHENG-JU CHIANG, 458 E. LAMBERT ROAD, FULLERTON, CA, 92835, US

(73) Assignee: FOXSEMICON INTEGRATED TECHNOLOGY, INC., Chu-Nan (TW)

(21) Appl. No.: 11/959,152

(22) Filed: Dec. 18, 2007

(30) Foreign Application Priority Data
Apr. 27, 2007 (CN) 200710074235.5

(51) Int. Cl. G09G 3/04

(52) U.S. Cl. 345/33

(57) ABSTRACT

A display device includes a display module and a magnetic bar. The display module includes a plurality of display cells. Each display cell includes an LED module, a supporting member located a side of the LED module and supporting the LED module and a control device disposed in the supporting member. The control device includes a switch connecting with the LED module and a magnet received in the supporting member. The LED module connects with poles of a power. When the magnetic bar moves towards or away from the display module, a magnetic force is generated between the magnet and the magnetic bar to control the magnet moves adjacent to or away from the LED module to illumine or quench the LED module.

### BACKGROUND OF THE INVENTION

1. Field of the Invention

The present invention relates to a display device and particularly to an LED display device.

2. Description of Related Art

Generally, blackboard is a reusable writing surface on which text or drawings are made with chalk or other erasable markers. During use, chalk produces a fair amount of chalk dust. These chalk dust pollutes the environment, and can cause respiratory problems, thus is very harmful to people's health.

What is needed, therefore, is a display device harmless to people's health and the environment.

### SUMMARY OF THE INVENTION

A display device includes a display module and a magnetic bar. The display module includes a plurality of display cells. Each display cell includes an LED module, a supporting member located a side of the LED module supporting the LED module and a control device disposed in the supporting member. The control device includes a switch connecting with the LED module and a magnet received in the supporting member. The LED module connects with poles of a power source. When the magnetic bar moves towards or away from the display module, a magnetic force is generated between the magnet and the magnetic bar for controlling the magnet to move adjacent to or away from the LED module to switch on or off the LED module.

Other advantages and novel features will become more apparent from the following detailed description of preferred embodiments when taken in conjunction with the accompanying drawings.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a partial assembled view of a display device in accordance with a first embodiment of the present invention.

FIG. 2 is a top view of a display cell of FIG. 1.

FIG. 3 is a cross sectional view of the display cell of FIG. 2 along line III-III thereof.

FIG. 4 is a partial assembled view of a display device in accordance with a second embodiment of the present invention.

FIG. 5 is a cross sectional view of a display cell of FIG. 4.

FIG. 6 is a partial assembled view of a display device in accordance with a third embodiment of the present invention.

FIG. 7 is a cross sectional view of the display cell of FIG. 6.

### DETAILED DESCRIPTION OF THE INVENTION

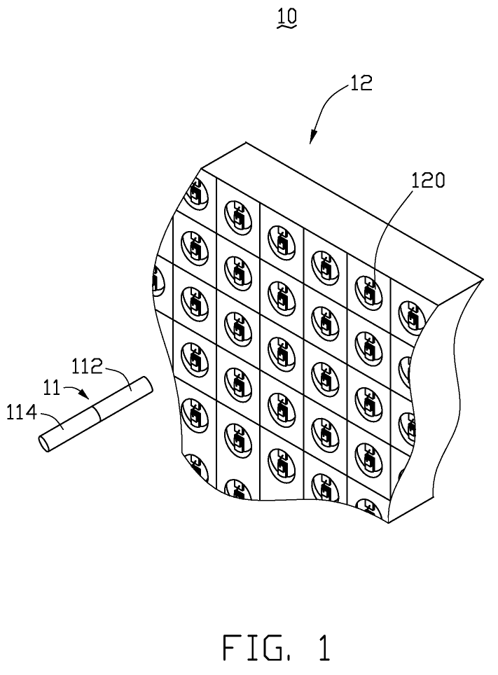

Referring to FIG. 1, a display device 10 of a present embodiment of the invention comprises a cylindrical magnetic bar 11 and a display module 12. The magnetic bar 11 comprises a first portion 112 and a second portion 114 opposite to the first portion 112. The first portion 112 is a north pole of the magnetic bar 111 and the second portion 114 is a south pole of the magnetic bar 11. The display module 12 includes a plurality of display cells 120 in array.

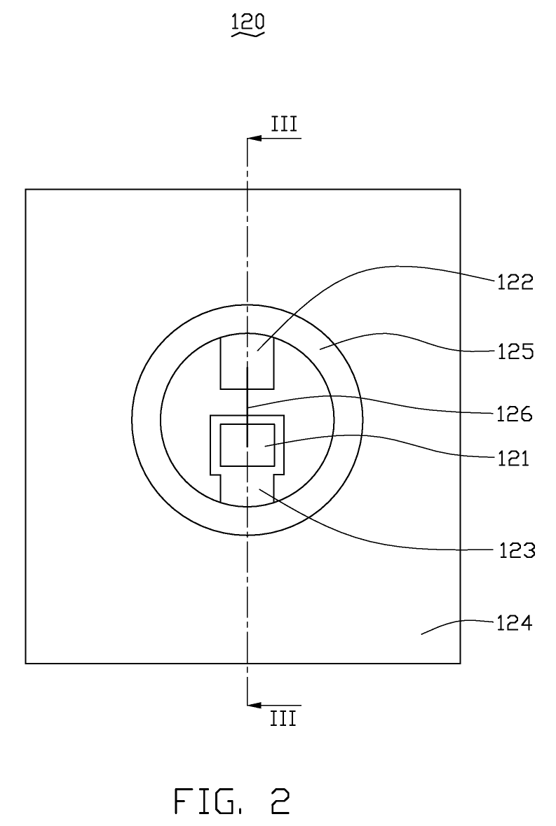

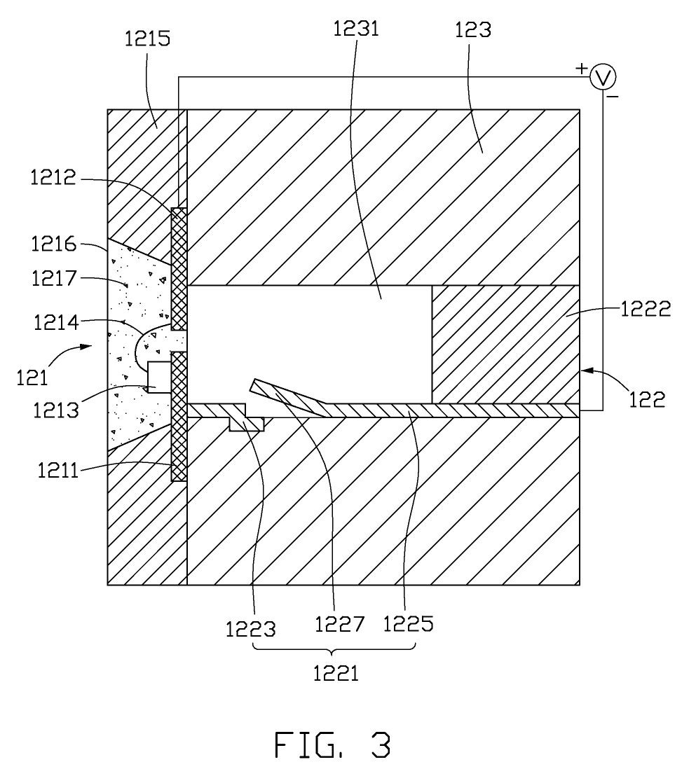

Referring to FIGS. 2 and 3, each of the display cells 120 comprises a LED module 121, a supporting member 123 located at a rear side of the LED module 121, and a control device 122 disposed in the supporting member 123 and opposite to the LED module 121.

The supporting member 123 is configured for supporting the LED module 121. The supporting member 123 has a cylindrical configuration and is made of non-conductive material. A through hole 1231 with a front opening and a rear opening is defined in the centre of the supporting member 123.

The LED module 121 is a hermetic cylinder and comprises an elongated first pole 1211, an elongated second pole 1212 located at a lateral side of the first pole 1211, an LED 1213 attached on the first pole 1211, a wire 1214 connecting with the LED 1213 and the second pole 1212, and a reflector 1215. The first and second poles 1211, 1212 are in alignment with each other and located at a bottom surface of the reflector 1215 and connected with the supporting member 123. The second pole 1212 connects with a positive pole (not labeled) of a power source. The power source typically includes a battery or other electrical power sources. The LED 1213 is located towards a bottom of a cup 1216. The cup 1216 has a bugle-shaped configuration with a front and rear opening (not labeled) thereof. The rear opening of the cup 1216 engages with the first and second poles 1211, 1212, and light radiated from the LED 1213 is projected the front opening of the cup 1216. The cup 1216 is filled with an encapsulant 1217 to protect the LED 1213. The reflector 1215 surrounds the cup 1216. The first pole 1211 and second pole 1212 are used to reflect light radiated by the LED 1213. In this embodiment, a rear surface of the LED module 121 rests on a front side of the supporting member 123; alternatively, the LED module 121 may have a non-conductive substrate (not shown) located at the rear surface thereof, and the substrate may rests on the front side of the supporting member 123.

The control device 122 comprises a switch 1221 and a cylindrical magnet 1222 received in the hole 1231 of the supporting member 123. In this embodiment, the magnet 1222 has a south pole facing the bottom surface of the LED module 121. The switch 1221 is made of conductive metal and adhered to an inner sidewall of the hole 1231 of the supporting member 123. The switch 1221 comprises a first connecting plate 1223, a second connecting plate 1225 and a spring plate 1227. The first connecting plate 1223 connects with the first pole 1211 of the LED module 121. The first connecting plate 1223 has a step (not labeled) towards the second connecting plate 1225. The second connecting plate 1225 extends from a rear end of the supporting member 123 towards the step of the first connecting plate 1223 and connects with a negative pole (not labeled) of the power source. The spring plate 1227 extends from the second connecting plate 1225 and cooperates with the step of the first connecting plate 1223. When the switch 1221 is closed, the spring plate 1227 electrically contacts with the step of the first connecting plate 1223 of the switch 1221, simultaneously the LED module 121 is turned on. Similarly, when the switch 1221 is opened, the spring plate 1227 is disconnected with the step of the first connecting plate 1223 and the LED module 121 is turned off.

Referring to FIG. 3, the second pole 1212 of the LED module connects with the positive pole of the power source and the switch 1221 of the control device 122 connects with the negative pole of the power source. When the first portion 112 (acted as the north pole) of the magnetic bar 11 moves towards the active LED 1213 of the display module 12, an attractive magnetic force is generated between the north pole of the magnetic bar 11 and the south pole of the magnet 1222. The magnetic force becomes stronger as the distance between the magnetic bar 11 decreases. When the attractive magnetic force is preferably sufficiently strong to overcome a gravitation of the magnet 1222, the magnet 1222 moves towards the LED module 121 until the switch 1221 is closed. Thus, each of the LED modules 121 is turned on and information is displayed by the LED modules 121 of the display module 12. According to different locations of the first portion 112 of the magnetic bar 11 near the display 12, different information is displayed on the display module 12. Similarly, when the second portion 114 of the magnetic bar 11 draws near to the LED module 121, the magnet 1222 moves far away the LED module 121 until the switch 1221 is opened; thus, the LED module 121 is turned off and information displayed by the display module 12 is erased.

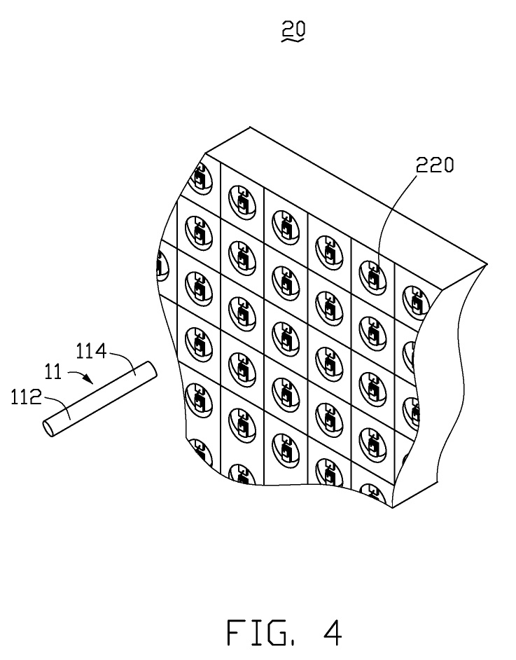

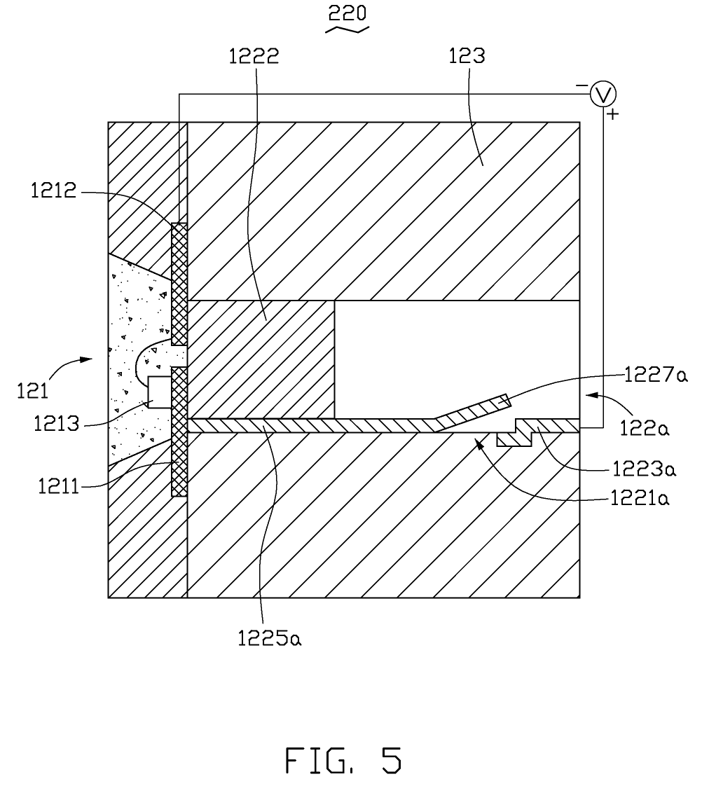

Referring to FIGS. 4 and 5, a display device 20 of a second embodiment of the present invent is shown. The display device 20 is similar to the display device 10 of the first embodiment of the present invention. The display device 20 comprises a plurality of LED cells 220 similar to the LED cells 120 of the first embodiment. Each of the LED cells 220 comprises a LED module 121, a supporting member 123 located at a rear side of the LED module 121 and supporting the LED module 121, and a control device 122a disposed in the supporting member 123 and opposite to the LED module 121. The control device 122a comprises a switch 1221a. The switch 1221a is different from the switch 1221 of the first embodiment. In this embodiment, the switch 1221a comprises a second connecting plate 1225a connecting with the first pole 1211 of the LED module 121, a spring plate 1227a extending from the second connecting plate 1225a, and a first connecting plate 1223a. The first connecting plate 1223a aligns with the second connecting plate 1225a and is located at the rear end of the supporting member 123 and connects with the positive pole of the power source. The second pole 1212 of the LED module 121 connects with the negative pole of the power source. When the second portion 114 of the magnetic bar 11 draws near to the south pole of the magnet 1222, the magnet 1222 moves away the LED module 121 towards the switch 1221a until the switch 1221a is closed. Thus, the LED module 121 is turned on and information is displayed by the LED module 121. When the first portion 112 of the magnetic bar 11 draws near to the south pole of the magnet 1222, the magnet 1222 moves towards the LED module 121 until the switch 1221a is opened, thus, the LED module 121 is turned off and the information displayed by the display module 12 is erased.

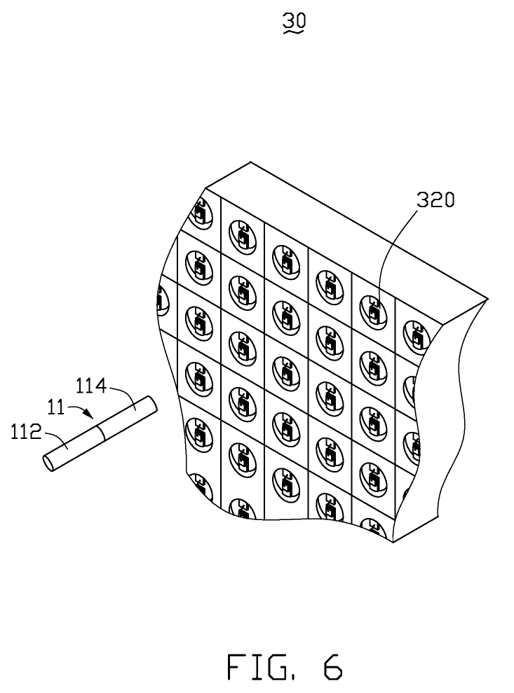

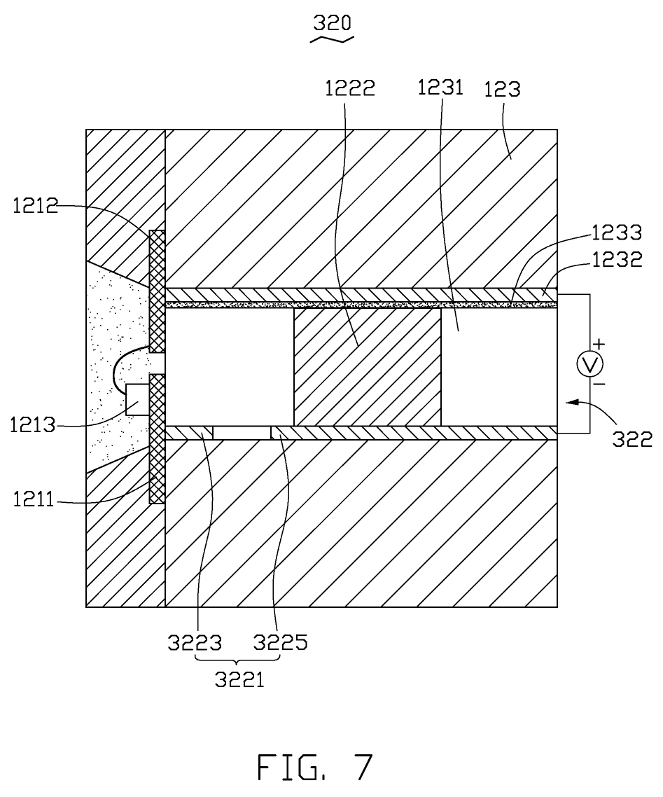

Referring to FIGS. 6 and 7, a display device 30 of a third embodiment of the present invent is shown. The display device 30 is similar to the display device 10 of the first embodiment of the present invention. The display device 30 comprises a plurality of LED cells 320 are different from the LED cells 120 of the first embodiment. First, a conductive layer 1232 is attached on the inner sidewall of the supporting member 123 and an insulator 1233 is attached on the conductive layer 1232. The conductive layer 1232 connects with the positive pole of the power source. Second, the display device 30 has a control device 322 consisted of a switch 3221 and the magnet 1222. The switch 3221 is far away from the insulator 1233 and comprises a first connecting plate 3223 and a second connecting plate 3225 away from the first connecting plate 3223. The first connecting plate 3223 connects with the first pole 1211 of the LED module 121, and the second connecting plate 3225 connects with the negative pole of the power source. When first portion 112 of the magnetic bar 11 is near to the magnet 1222, the magnet 1222 moves towards the LED module 121 until it connects with the first and second connecting plates 3223, 3225; in that state, the switch 3221 is closed, and the LED module 121 is turned on. When the second portion 114 of the magnetic bar 11 is near to the magnet 1222, and the magnet 1222 moves away from the switch 3221; in that state, the switch 3221 is opened, and the LED module 121 is turned off.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A display device comprising:
a display module comprising a plurality of display cells, each display cell comprising:
an LED module, a supporting member located a side of and supporting the LED module, and a control device disposed in the supporting member; the control device comprising a switch connecting with the LED module and a magnet received in the supporting member, the LED module connecting with poles of a power source; and
a magnetic bar for switching on or off the display module;
wherein when the magnetic bar moves towards or away from the display module, a magnetic force is generated between the magnet and the magnetic bar to control the magnet moves adjacent to or away from the LED module to switch on or off the LED module.

2. The display device of claim 1, wherein the supporting member is made of non-conductive material, a through hole is defined in the centre of the supporting member, the conductive member is received in the hole.

3. The display device of claim 2, wherein the switch is made of conductive metal and adhered to an inner sidewall of the supporting member.

4. The display device of claim 3, wherein the switch comprises a first connecting plate connecting the LED module, a second connecting plate spaced to the first connecting plate and connecting with a pole of the power, and the magnet connects with the first and the second connecting plates.

5. The display device of claim 4, wherein the magnetic bar has a first portion and a second portion opposite to the first portion, when the first portion faces to the magnet and the magnetic force is generated between the first portion of the magnetic bar and the magnet is sufficiently strong, the magnet moves between the first and second connecting plates and the LED module is switched on.

6. The display device of claim 5, wherein when the second portion of the magnetic bar faces to the magnet and the magnetic force is generated between the magnetic bar and the magnet sufficiently strong, the magnet moves away from the first connecting plate and the LED module is switched off.

7. The display device of claim 3, wherein the switch comprises a first connecting plate connecting the LED module, a second connecting plate apart from the first connecting plate and connecting with a pole of the power, and a spring plate extending from the second plate connecting the first and second connecting plate.

8. The display device of claim 3, wherein the switch comprises a first connecting plate connecting with a pole of the power, a second connecting plate connecting the LED module and spaced to the first connecting plate, and a spring plate extending from the second plate connecting the first and second connecting plate.

9. The display device of claim 4, wherein a conductive layer is attached on the inner sidewall of the supporting member and an insulator is attached on the conductive layer, and the conductive layer connects with the LED module and a pole of the power.

10. The display device of claim 1, wherein the display cells are arranged in an array.

11. A display device comprising
a power supply;
an LED;
a switch connected between power supply and the LED;
a supporting member with the LED mounted thereon, the supporting member defining a channel therein;
a first magnet received in the channel the supporting member, the first magnet being movable between a first position where the switch is triggered on and a second position where the switch is triggered off; and
a second magnet for being disposed adjacent to the LED so as to move the first magnet between the first position and the second position in the channel by magnetic attraction and repellence.

12. The display device of claim 11, wherein the switch comprises a first fixed part and a second deformable part, the second deformable part is deformed to be connected with the first fixed part when the first magnet is in the first position, and the second deformable part is rebounded to disconnected with the first fixed part when the first magnet is in the second position.
